(19) United States
(12) Patent Application Publication
(10) Pub. No.: US 2025/0172203 A1
(43) Pub. Date: May 29, 2025

(54) ELECTRONICALLY CONTROLLED DRIVELINE DISCONNECT

(71) Applicant: GKN Automotive Limited, Birmingham (GB)

(72) Inventor: Rory M. Johnson, Grand Blanc, MI (US)

(21) Appl. No.: 18/960,499

(22) Filed: Nov. 26, 2024

Related U.S. Application Data
(60) Provisional application No. 63/603,201, filed on Nov. 28, 2023.

(51) Int. Cl. F16H 48/34; F16H 48/24

(52) U.S. Cl. CPC F16H 48/34; F16H 48/24; F16H 2048/346

(57) ABSTRACT

A vehicle driveline disconnect device and a method of determining the status of a clutch of a driveline disconnect device includes steps to positively determine a position of the clutch. The steps may include detecting termination of an activation signal for an actuator of a clutch through which torque is selectively transmitted to one or more axles of a vehicle, determining that the clutch is in a second position and not the first position, applying a detection current to the actuator, wherein the detection current is of a lower magnitude than the current of the activation signal, and determining the position of the clutch as a function of the current in the actuator after application of the detection current.

### REFERENCE TO RELATED APPLICATIONS

This application claims the benefit of U.S. Provisional Application Ser. No. 63/603,201 filed on Nov. 28, 2023 the entire content of which is incorporated herein by reference in its entirety.

### TECHNICAL FIELD

The present disclosure relates generally to a driveline disconnect assembly.

### BACKGROUND

Some driveline disconnect assemblies include a clutch through which torque is selectively transmitted. When torque is transmitted by the clutch, one or more axles of the vehicle are driven by the torque, and when torque is not transmitted by the clutch, the axles are not driven for rotation and the axles instead rotate relative to the clutch. Some clutch actuation mechanisms fail to positively achieve two positions of the clutch on command, and the result is that the disconnect device may erroneously be in a state (i.e. connected or disconnected) that is not desired.

### SUMMARY

In at least some implementations, a method of determining the status of a clutch of a vehicle driveline disconnect device includes:
detecting termination of an activation signal for an actuator of a clutch through which torque is selectively transmitted to one or more axles of a vehicle;
determining that the clutch is in a second position and not the first position;
applying a detection current to the actuator, wherein the detection current is of a lower magnitude than the current of the activation signal; and
determining the position of the clutch as a function of the current in the actuator after application of the detection current.

In at least some implementations, when the determined position of the clutch after application of the detection current is not the first position, applying another detection current to the actuator and determining again the position of the clutch after reapplication of the detection current.

In at least some implementations, the clutch includes a first clutch member and a second clutch member that is movable relative to the first clutch member, and a spring is provided that resists movement of the second clutch member toward the first clutch member, and wherein the detection current does not provide a force great enough to overcome the spring force to an extent wherein the second clutch member becomes engaged with the first clutch member.

In at least some implementations, the current in the actuator after application of the detection current is of a magnitude that corresponds to the inductance within the actuator which changes as the position of the actuator changes.

In at least some implementations, the clutch includes a first clutch member and a second clutch member that is movable relative to the first clutch member, and the actuator includes a coil and a plunger that moves relative to the coil to move the second clutch member, and wherein the activation signal is applied to the coil to cause movement of the plunger in a direction associated with movement of the second clutch member away from the first clutch member, and the movement of the plunger induces a current in the actuator that causes a first spike in a current profile of the actuator and the step of determining that the clutch is in a second position and not the first position is accomplished by comparison of the first spike to at least one threshold.

In at least some implementations, the at least one threshold relates to a magnitude of current change in the first spike, the duration of the spike, the time between occurrence of the spike and receiving the signal, occurrence of the spike before the current in the coil falls below a threshold current, or a combination of two or more of these things.

In at least some implementations, the first spike satisfies the at least part of the at least one threshold when the first spike occurs before the current in the coil fully decays.

In at least some implementations, the signal indicative that the clutch should be in the first position is the termination of an activation signal for the actuator, and wherein the first spike satisfies the at least part of the at least one threshold when the first spike occurs within 30 ms to 150 ms of the termination of the activation signal.

In at least some implementations, the current in the actuator after application of the detection current is of a magnitude that corresponds to the inductance within the actuator which changes as a position of the plunger changes.

In at least some implementations, a slope or a peak magnitude, or both, of the current in the actuator after application of the detection current is different when the plunger is in a first position than when the plunger is in a second position.

In at least some implementations, the detection current is of lower magnitude than the current of the activation signal.

In at least some implementations, the activation signal is applied to the coil to cause movement of the plunger, and movement of the plunger induces a current in the actuator that creates a first deviation in a current profile of the actuator, and wherein the step of determining that the clutch is in a second position and not the first position is accomplished at least in part by determining if the first deviation occurred in the current profile.

In at least some implementations, the first deviation has a first deviation magnitude that is based on one or both of a total current change from a start of the first deviation to a peak of the first deviation, or the time duration of the deviation, and wherein the first deviation magnitude is compared to a first threshold to determine if the clutch is in the first position.

In at least some implementations, a driveline disconnect device includes an outer housing, pinion and side gears received in the outer housing with the side gears adapted to be connected to a separate shaft that drives a wheel of a vehicle, an inner housing coupled to a pinion shaft of the pinion gears, and a clutch, an actuator for the clutch and a controller coupled to the actuator. The clutch has a first clutch member that is connected to the inner housing, and a second clutch member that is connected to the outer housing for rotation with the outer housing. The second clutch member is movable relative to the first clutch member to define an engaged position in which torque is transmitted through the clutch and to the side gears, and a disengaged position in which torque is not transmitted through the clutch and to the side gears. The actuator has a coil and a plunger that moves relative to the coil to move the second clutch member. The controller is adapted to execute instructions to:
detect an activation signal of an actuator of the clutch indicative that the clutch should be in the disengaged position;
determine that the clutch is in the engaged position and not the disengaged position;
apply a detection current to the actuator, wherein the detection current is of a lower magnitude than the current of the activation signal;
determine the position of the clutch as a function of the current in the actuator after application of the detection current; and
when the determined position of the clutch after application of the detection current is not the disengaged position, apply another detection current to the actuator and determine again the position of the clutch after reapplication of the detection current.

### BRIEF DESCRIPTION OF THE DRAWINGS

The following detailed description of preferred embodiments and best mode will be set forth with reference to the accompanying drawings, in which:

FIG. 1 is a cross-sectional view of a portion of a differential with an electrically actuated clutch shown in a disengaged position;

FIG. 2 is a cross-sectional view of a portion of the differential with the clutch shown in an engaged position;

FIG. 3 is an illustration of a current profile resulting from superposition of current supplied to a wire with current induced in the wire;

FIG. 4 is an illustration of a current profile representative of a situation in which an actuator for the clutch was activated and the clutch relatively quickly changed from a disengaged position to an engaged position;

FIG. 5 is an illustration of a current profile representative of a situation in which the actuator is activated but the clutch achieving the engaged position was delayed;

FIG. 6 is an illustration of a current profile representative of a situation in which the actuator is deactivated and the clutch relatively quickly changes from the engaged position to the disengaged position;

FIG. 7 is a perspective view of the plunger;

FIG. 8 is a perspective view of the plunger and second clutch member illustrating engaged, axially opposed feet on the plunger and second clutch member;

FIG. 9 is a current profile showing application of three separate detection currents;

FIG. 10 is a flow chart for a process for actuating the actuator and determining the status of the differential assembly clutch; and

FIG. 11 is a flow chart for a process for deactuating the actuator and determining the status of the differential assembly clutch.

### DETAILED DESCRIPTION

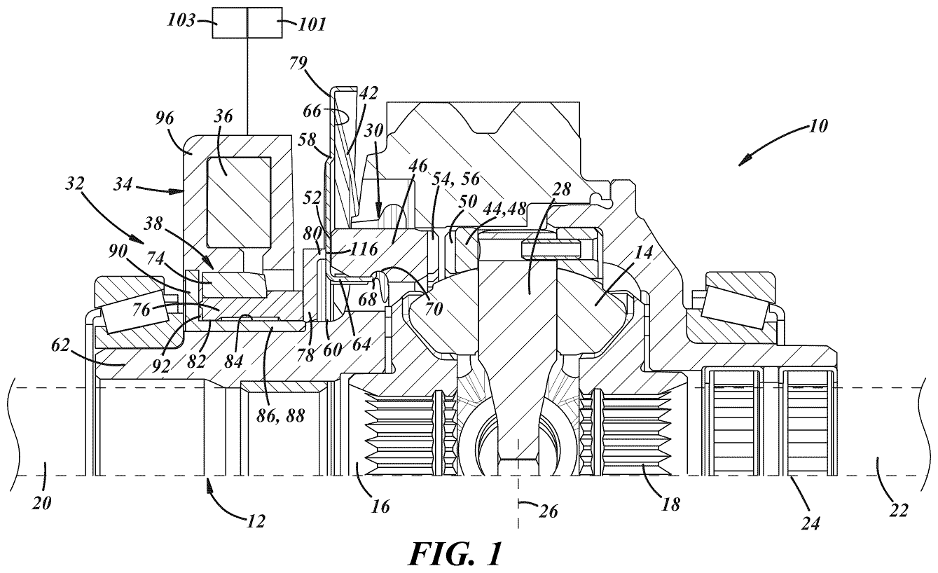

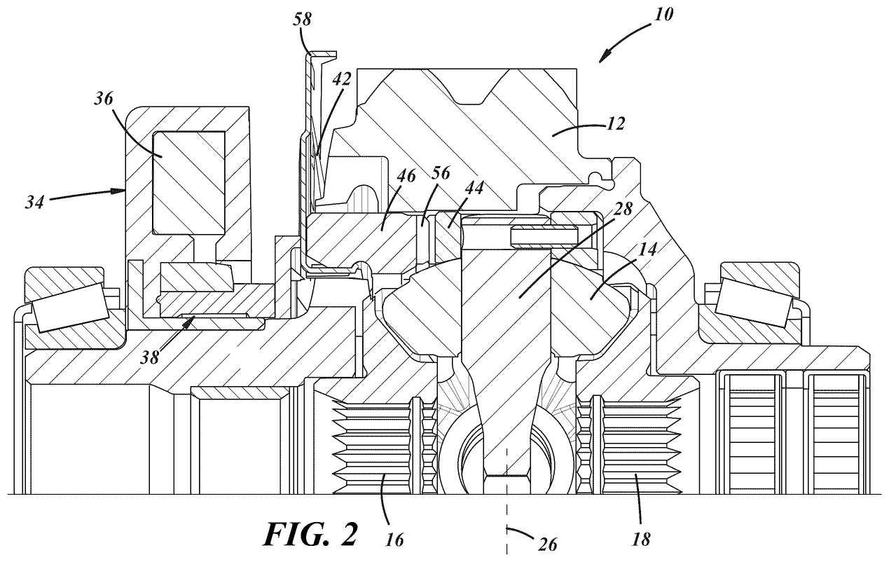

Referring in more detail to the drawings, FIGS. 1 and 2 illustrate a portion of a differential 10 such as may be used in an e-axle (e.g. an e-motor driven final drive unit, or any drive assembly). The differential 10 includes an outer housing 12, two or more pinion gears 14 (only one shown in FIGS. 1 and 2), and a pair of side gears 16, 18 that are arranged to be coupled to rotating shafts 20, 22 that may drive, for example, wheels of a vehicle. Thus, the side gears 16, 18 rotate with the shafts 20, 22 (shown diagrammatically in FIG. 1) about a shaft axis 24 and the pinion gears 14 are rotatable about an axis 26 defined by a pinion gear shaft 28 extending through the pinion gears.

The differential 10 also includes a clutch assembly 30 that is driven by an actuator 32 having a solenoid 34 with an annular wire coil 36 and a drive member that may include an armature or plunger 38 that may be received at least partially radially inwardly of and axially overlapped with the coil 36. In at least some implementations, the plunger 38 is also annular, the plunger and coil 36 are coaxially arranged about axis 24 and are carried by the outer housing 12 of the differential 10 for rotation with the outer housing 12. One shaft 20 extends coaxially through a portion of the housing 12 that extends through the coil 36 and plunger 38. Electric power is supplied to the coil 36 to generate a magnetic field that displaces the plunger 38 relative to the coil 36 and outer housing 12 from a first or retracted position (FIG. 1) to a second or advanced position (FIG. 2). To facilitate return of the plunger 38 from the second position back to the first position when power is not provided to the coil 36, a biasing member, such as a spring 42 may act on the plunger 38, or on a component engaged with the plunger, as set forth below. In at least some implementations, the clutch assembly 30 is engaged when the plunger 38 is in the second position and the clutch assembly 30 is disengaged when the plunger 38 is in the first position. While in the example shown the plunger 38 is in its second position when power is provided to the coil 36 and the plunger 38 moves to the first position when power is not supplied to the coil 36, the opposite could be true if desired (e.g. the clutch assembly 30 could be moved to the engaged position by the biasing member 42 and disengaged by powering the coil 36).

In at least some implementations, the clutch assembly 30 is an engaging clutch such as a dog clutch, and includes a first clutch member 44 that is not movable in an axial direction (defined by the central axis 24 of the plunger), and a second clutch member 46 that is movable in the axial direction relative to the first member 44.

In at least some implementations, the clutch assembly 30 may be used, for example, in a so-called free running differential 10, that selectively interrupts and permits torque transmission therethrough. In this device, a first rotating body is the outer differential housing 12 and a second rotating body is an inner housing 48, and the first rotating body and the second rotating body rotate about a common rotational axis 24. The inner housing 48 includes clutch teeth or, as in the implementation shown, the inner housing 48 is connected to the first clutch member 44 that includes the clutch teeth 50. In the example shown, the first clutch member 44 is coupled to the inner housing 48 and is constrained against axial movement relative to the second clutch member 46.

Referring to FIG. 2, the second clutch member 46 may be coaxial with the axis 24 of the plunger 38, and may be received outboard of the pinion gear 14 (i.e. farther from the axis 24 than the pinion gear 14). The second clutch member 46 may include a rear face 52 closer to the plunger 38 than a front face 54, with the front face 54 having at least one engagement feature, such as gear or clutch teeth 56 (e.g. dog clutch teeth) configured to engage a corresponding engagement feature (e.g. gear or dog clutch teeth 50) formed on the first clutch member 44.

In at least some implementations, the second clutch member 46 may be connected to a carrier 58. The carrier 58 may radially position the second clutch member 46 and in the implementation shown, the carrier 58 is annular and includes a central opening 60 received over a tubular portion 62 of the outer housing 12 about which the plunger 38 is received. An axially extending support may be defined by an annular flange 64, or spaced apart fingers radially spaced from the opening 60, to connect the carrier 58 to the second clutch member 46 at a location radially spaced from the tubular portion 62 of the outer housing 12, in at least some implementations. The second clutch member 46 may be trapped between a first face 66 of the carrier 58 adjacent to the rear face 52 of the second clutch member 46 and a radially bent end 68 of the support surface 64 that engages a radially extending surface of the second clutch member 46, shown as being defined in a groove 70 formed in a radially inner surface of the second clutch member 46. In this way, the carrier 58 and second clutch member 46 move together in both directions of movement of the second clutch member 46. The spring 42 may be retained by and act on the first face 66 of the carrier 58 to bias second clutch member 46 to a retracted position in which the second clutch member teeth 56 are not meshed with the first clutch member teeth 50. The spring 42 may be received between a portion of the outer housing 12 and a portion of the carrier 58 and may be located radially inwardly or radially outwardly of the second clutch member 46, or both (e.g. more than one spring may be provided). Like the coil 36 and plunger 38, the second clutch member 46 also is carried by and rotates with the outer housing 12.

The plunger 38 may be formed from multiple materials including a material that is magnetically responsive to the magnetic field generated by the coil 36, and at least one other material that may or might not be responsive to the magnetic field. Thus, when the magnetic field is generated by the coil 36, the plunger 38 may be driven from one position to another (e.g. from the retracted to the advanced position). As used herein, a material is responsive to a magnetic field if a magnetic field of the magnitude generated by a solenoid 34 of the type used in applications such as that described herein, may cause a component formed of or including such material to be displaced.

In at least some implementations, as shown in FIGS. 1 and 2, the plunger 38 includes a main body with a central axis that may be coaxial with axis 24, and the plunger 38 may be defined by a first body 74 and a second body 76 that are coupled together and move as one unit or component and are not separated during use. The first body 74 may be formed from a magnetically responsive material and may be received adjacent to and radially inwardly of the coil 36, with a small air gap between them. The second body 76 may have at least a portion that is radially inward of at least a portion of the first body 74. The second body 76 may be annular and may, in at least some implementations, radially overlap part of the first body 74. The second body 76 may be conveniently overmolded onto the first body 74 to facilitate forming the second body and connecting together the first and second bodies, however other forming processes such as but not limited to casting, stamping or extruding may be used.

In the implementation shown, the plunger 38 includes or is associated with a radially outwardly extending end piece 78 that has an axially extending rim 80 that engages a second face 79 the carrier 58 at a position radially overlapped by the second clutch member 46. That is, the rim 80 is radially aligned with the second clutch member 46. The end piece 78 may be formed in the same piece of material as the second body 76 or as a separate component that is fixed to the second body 76 in at least some implementations. Of course, other implementations may be utilized, as desired. The second body 76 may be formed from a material that is not magnetically responsive (e.g. plastic, aluminum, stainless steel, etc.), and may provide a magnetic flux shield of sorts that improves the magnetic field strength on or in the area of the first body 74 to ensure proper response of the plunger 38 when the coil 36 is energized. In this way, the magnetic field is more concentrated or stronger in the area of the first body 74 to increase the magnetic flux at or in the first body and improve the responsiveness of the plunger 38 to the generated magnetic field.

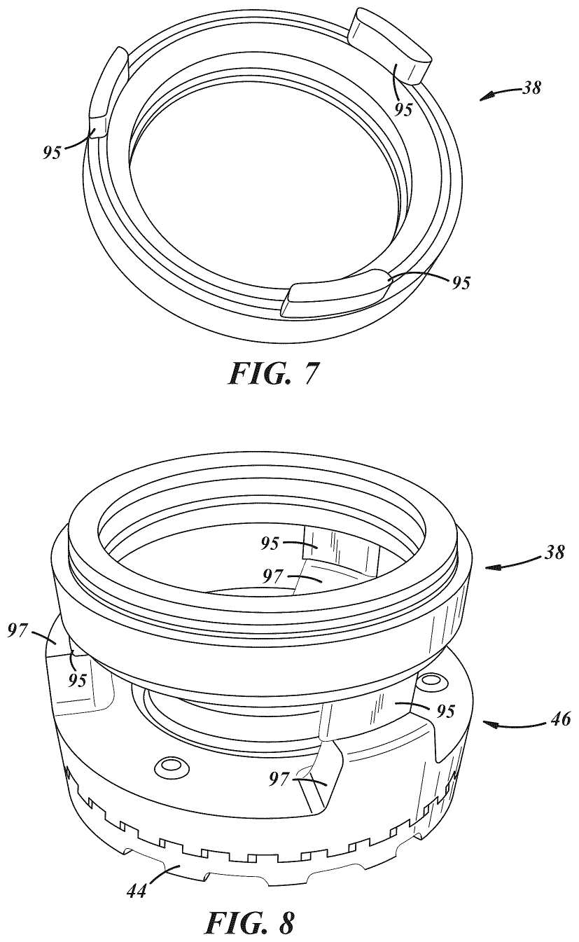

As shown in FIGS. 1 and 2, the second body 76 may have an inner surface 82 that is received adjacent to or around a surface 84 of the differential housing 12. The inner surface 82 may define a pilot diameter for receipt of the plunger 38 over the annular surface 84 of the differential housing 12 for guided linear, axial movement of the plunger 38 relative to the differential housing 12. In at least some implementations, the housing surface 84 may be defined by a sleeve 86 received over the tubular extension of the housing 12. The sleeve 86 may include an axially extending portion 88 with an outer surface that defines at least part of the surface 84, and a radially extending portion 90 adjacent to a rear face 92 of the plunger 38 (i.e. the face or side farthest from the second clutch member 46) and which may limit movement of the plunger 38 in that direction. The radially extending portion 90 may also be connected to a coil housing 96 in which the coil 36 is received, to radially position and retain the coil housing 96 relative to the outer housing 12. Other or additional retention features may be provided to mount the coil 36 on or relative to the outer housing 12. In at least some implementations, such as is shown in FIGS. 7 and 8, the plunger 38 may include axially extending feet 95 that extend through openings in the housing and engage axially extending feet 97 of the second clutch member 46.

In FIG. 1, the differential 10 is shown with the clutch 30 in a disengaged position. In the illustrated implementation, in the disengaged position of the clutch 30, the coil 36 is not powered, the plunger 38 is in its first position (i.e. retracted position) and the second clutch member 46 is not engaged with the first clutch member 44 (that is, second clutch member teeth 56 are not meshed with the first clutch member teeth 50). In the disconnected position, the shafts/axles 20, 22 are not actively driven and may rotate relative to the second clutch member 46 and outer housing 12.

To change the clutch 30 from the disengaged position to the engaged position, shown in FIG. 2, the coil 36 is powered to generate a magnetic field that drives the plunger 38 its second position (i.e. advanced position) which drives the second clutch member 46 into engagement with the first clutch member (i.e. teeth 56 engage and mesh with teeth 50). In this position, the inner housing 48 is coupled to and rotates with the outer housing 12 and torque is transmitted to the axles 20, 22.

To control actuation of the actuator 32, the coil 36 may be communicated with a processor 101 or controller (FIG. 1), and the processor 101 may selectively accesses memory 103 and/or other computer-readable medium that includes instructions executable by the processor for selectively energizing the coil and driving the plunger, and for otherwise carrying out methods and steps as described herein. For example, the processor 101 may access a vehicle control module configured to provide directives for other vehicle systems. The processor 101 may include one or multiple processors or electronic controllers, capable of performing instructions and executing algorithms, as is known in the art. The memory 103 may be any type of volatile or non-volative memory, as is known in the art.

Actuation of the coil 36 may not guarantee that the second clutch member 46 properly engages and couples with the first clutch member 44. For example, the axial ends of the teeth 50, 56 may align and, at least temporarily, face-to-face meshing of the teeth 50, 56 may be prevented. By contrast, the teeth 50, 56 are fully meshed and drivingly engaged in FIG. 2. In other words, the teeth 50, 56 may at times be positioned such that activation of the coil 36 does not properly engage the second clutch member 46 and first clutch member 44. Additionally, the teeth 50, 56 may skip or otherwise fail to engage even though the coil 36 is activated.

Deactivation of the actuator 32/coil 36 similarly does not guarantee the disengagement of the second clutch member 46 from the first clutch member 44. In other words, when the activation signal is removed from the actuator 32 pressure or forces on the meshed teeth 50, 56 may prevent the second clutch member 46 from immediately disengaging from the first clutch member 44, and thus, the differential 10 may remain in the engaged position shown in FIG. 2 for at least some time after the coil 36 is not powered. The plunger 38 may become a ‘free agent’ during this time, as the deactivated coil is not keeping it in contact with the second clutch member 46, and the spring 42 is not keeping it in contact with the second clutch member due to pressure or forces on the meshed teeth. If the plunger 38 separates from the second clutch member 46 in such a situation, attempts to determine whether the differential 10 is engaged or disengaged by monitoring the position of the plunger 38 will not be effective because the position of the plunger would not represent the position of the second clutch member 46. Therefore, a mechanism by which to keep the plunger 38 in contact with the second clutch member 46 is required at least during this time for the purpose of distinguishing between D&E (deactivated and engaged) and D&D (deactivated and disengaged) states. This is passively but effectively accomplished by the repeated application of Detection Current as described later in this disclosure. The detection current is sufficient to keep the plunger 38 coupled against the second clutch member 46, but not sufficient to cause the second clutch member to overcome the force of the spring 42. In this way, even with application of detection current, the actuator is not sufficiently powered to cause inadvertent engagement of the clutch.

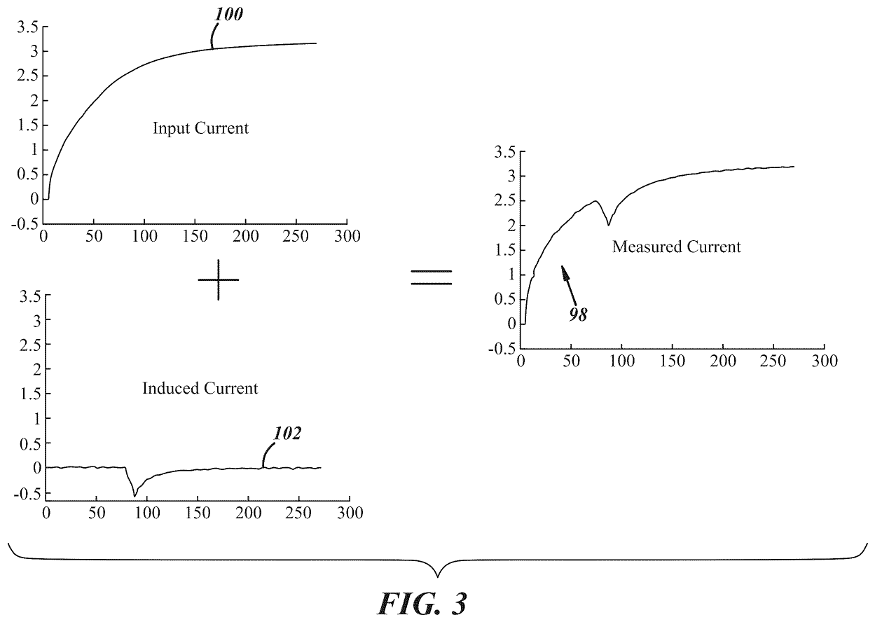

Because activation of the solenoid 34 does not guarantee engagement of the clutch 30 and deactivation of the solenoid 34 does not guarantee disengagement of the clutch 30, the actual states or positions of the clutch may be sensed or determined in one or more ways. For example, the processor 101 may be configured to be able to determine the actual status of the clutch, i.e. in a disengaged position (FIG. 1), the engaged position (FIG. 2), an activated but disengaged position, or in a deactivated but engaged position. The processor 101 may determine changes in the clutch without an independent position sensor and the associated wiring and cost thereof. To this end, processor 101 may execute instructions related to a current profile 98 in the solenoid (see FIG. 3) to determine an actual status of the clutch 30.

As illustrated in FIG. 3, the current profile 98 is comprised of the activation signal 100 applied or removed from the solenoid 34 and/or coil 36, in addition to the induced current 102 generated by movement of the plunger 38 relative to the coil 36. Thus, the current profile 98 is a combination of the activation signal 100 and the induced current 102 which provides information about whether power is provided to the coil (e.g. the activation signal) as well as movement of the plunger relative to the coil (the induced current). The current profile 98 can be analyzed according to instructions executed by the processor 101 in real-time or near real-time to monitor and determine a position of the plunger which corresponds to the position of the second clutch member 46, and thus, whether the differential 10 is engaged or disengaged.

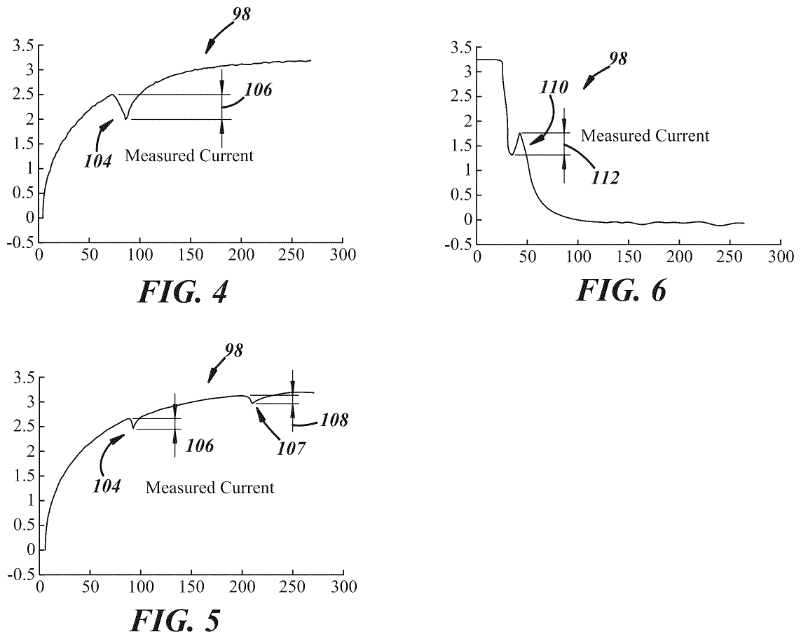

FIG. 4 is an illustration of a current profile 98 generated by the transition of differential 10 from the disengaged position (FIG. 1) to the engaged position (FIG. 2). In the example shown in FIG. 4, the majority of current profile 98 is a relatively smooth ascending curve representing application of the activation signal 100 and an increase in current. A portion of the current profile 98, however, contains a first deviation 104 generated by the movement of the plunger 38 relative to the coil 36 and to the engaged position (FIG. 2) which induces a current in the coil as noted above. The first deviation 104 includes a first deviation magnitude 106 which may be commensurate with the total current change from a start of the deviation to a peak, may relate to the time duration of the deviation, or a combination of the two. The first deviation magnitude 106 (actuated and engaged, referred to as “A&E” hereinafter) is representative of the nature of the travel of the clutch 30 (e.g. second clutch member 46) to its engaged position. For example, when the second clutch member 46 travels from the disengaged position to the engaged position relatively quickly, the first deviation magnitude 106 will be greater than if the plunger travel is slower. Other factors may affect the deviation magnitude 106, and merely as examples, the size or weight of the plunger 38, maximum current in the wire, number of turns in the coil 36, gauge of the wire, and/or the size or weight of other elements in communication with the plunger (for example, components of the differential 10), may affect the current induced in the coil upon movement of the plunger, and hence, the deviation magnitude 106 for a given differential 10.

Therefore, the first deviation 104 may be analyzed according to instructions executed by the processor 101 to determine if and when the engaged position is actually achieved. In at least some implementations, the first deviation magnitude 106 may be compared to a first threshold, which may be associated with or correspond to a nominal deviation magnitude resulting from achieving the engaged position instantly or nearly instantly. If the first deviation magnitude 106 is equal to or greater than the first threshold, then the processor 101 determines that the differential 10 achieved and is in the engaged position. If the first deviation magnitude 106 is less than the first threshold, the processor 101 determines that the differential 10 is in the activated but disengaged position.

The occurrence of a first deviation 104 of a magnitude smaller than the first threshold is illustrated in FIG. 5 which shows a first deviation magnitude 106A&D (activated and disengaged) that is of lesser magnitude than the deviation 106A&E shown in FIG. 4. When a first deviation magnitude 106A&D less than the first threshold is detected, the system continues to monitor the current profile 98 for occurrence of a second deviation 107 having a second deviation magnitude 108. The second deviation 107 occurs upon further movement of the plunger 38 relative to the coil 36 which induces a current in the coil. This further movement of the plunger 38 indicates that the second clutch member 46 achieved the engaged position after initially failing to do so. Reliably determining the engaged position of the second clutch member 46 and hence the differential 10, can be useful for a wide variety of automotive applications.

Further, in a similar fashion, it can be determined if the differential 10 is in a deactivated but engaged status. In such an instance, the power to the coil 36 has been terminated so the electromagnetic force displacing the plunger 38 to its advanced position has also been terminated, yet the second clutch member 46 remains at least partially advanced often due to forces holding the second clutch member 46 in engagement with the first clutch member 44. This is sometimes called a “torque trapped” situation. Contaminants or other interference in the path of the movement of the plunger 38 and/or second clutch member 46 may also inhibit or prevent return movement of the plunger 38 to its retracted position. In any event, in this situation, the coil 36 is not powered and the second clutch member 46 is in the engaged position.

FIG. 6 is an illustration of a current profile 78 generated by the transition of the actuator 32 from the engaged position to the disengaged position. As can be seen, the current profile 78 illustrated in FIG. 6 includes a precipitous drop represented by the removal of the activation signal 100. The current profile 98, however, contains a relatively quickly occurring first spike 110 generated by the movement of the plunger 38 relative to the coil 36 and into the disengaged position. The relatively quickly occurring first spike 110 has a first spike magnitude 112. The first spike 110 may be present in a primary transition of the current profile 98 from a current level associated with continued activation of the actuator 32 (shown in FIG. 6 to be 3.25 amps) to a lower current that may include a fully decayed current at about zero amps. In the example illustrated in FIG. 6, the current decays to zero amps in about 100 ms, and the first spike 110 occurs before full current decay. In at least some implementations, the first spike 110 occurs within 30 to 150 ms of coil deactivation. In at least some implementations, the first spike 110 associated with rapid return of the second clutch member 46 to the disengaged position may occur before the current decays below approximately 0.005 Amperes.

To determine whether the second clutch member 46 has moved to the disengaged position, the first spike 110 may be compared to one or more thresholds (which may individually or collectively be referred to as a second threshold) which may, in at least some implementations, relate to the magnitude 112 of the spike (i.e. the amount of current change during the spike), the duration of the spike, the amount of time between the spike and deactivation of the coil 36, presence of the spike before the current in the coil falls below a threshold, or a combination of two, three or all of these criteria. If the comparison of the first spike 110 is satisfactory (e.g. the magnitude 112 is above a threshold and/or the timing/current threshold is satisfied), then it may be determined that the second clutch member 46 has moved to the disengaged position (and hence, the differential 10 is in its disengaged position).

If, however, the second clutch member 46 remains in the engaged position after removal of the activation signal 100, then the first spike 110 will not satisfy the condition(s) of the second threshold. The processor 101 may then execute a process set forth shortly thereafter which infers a difference in distance of the clutch between the engaged and disengaged position to determine the state of the clutch.

For example, determinations of the state of the second clutch member 46, and hence, the differential 10, can be made with only the components of the second clutch member 46, and without the cost and complexity of independent sensor assemblies. In addition, although the superposition current may be adequate for proper determination of differential state change, it is contemplated that the present system may be utilized in combination with other status verifying methodologies, e.g., wheel speed sensing systems or independent transducer systems.

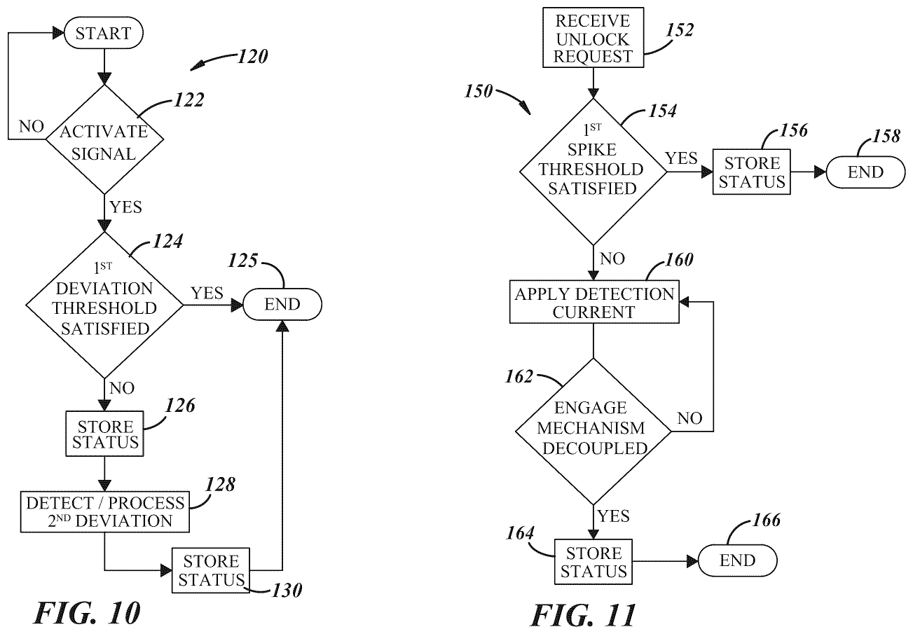

Turning now to FIG. 10, one implementation of a process 120 for actuating a clutch from a disengaged to an engaged position is illustrated. Process 120 begins at step 122 wherein it is determined if an activating signal has been provided to the coil to move the clutch to the engaged position. In at least some implementations, the current initially supplied to drive the plunger 38 to its advanced position may be greater than a current applied to hold the plunger in its advanced position. This may be achieved in various ways, including with a pulse width modulated power supply to the coil 36. Accordingly, to determine if an activation signal has been provided, the system may check for a current in the coil 36 above a threshold (which may be called a fourth threshold). If it is determined that an activation signal has been provided, the process proceeds to step 124. If it is determined that an activation signal has not been received, the process may loop back to the start. This process could also be a subroutine for other control processes, and as such, may only begin after an activation signal is detected. In that case, the process would essentially begin at step 124.

In step 124, a current profile associated with the activation signal is monitored until a first deviation occurs and the first deviation is compared to a first threshold. If the first threshold is satisfied, it is determined that the clutch achieved the engaged position and the method ends at 125. The status of the clutch may be stored in memory, if desired. If the first threshold is not satisfied, it is determined that the clutch is in an activated but disengaged condition and the process proceeds to step 126.

In step 126, the status of the clutch may be recorded, e.g. in the memory. For example, processor 101 may be associated with memory 103 that stores at least the most recently determined differential assembly status. The stored differential assembly status may then be selectively retrieved by processor 101 or any other vehicle system or processor in communication with the memory, as may be convenient. For example, vehicle stability control systems, vehicle traction control systems, or anti-lock braking systems may selectively retrieve this information from the memory as may be convenient.

The process may then proceed to step 128 wherein the current profile is monitored to determine later occurrence of a second deviation. Upon detecting a second deviation, it may be compared to a threshold, if desired. Otherwise, occurrence of a second deviation (or an occurrence that satisfies at least one threshold) indicates that the plunger has moved to its advanced position which is associated with the engaged position of the clutch, and the process may end at 125. The status of the clutch may be stored in memory in step 130 before the process ends, if desired.

To determine if the clutch has moved to the disengaged position upon deactivation of the locking signal, the process 150 shown in FIG. 11 may be used. This process 150 may be a continuation of the process 120 or a subroutine from another process or program. The process 150 may begin at 152 upon detection of a unlock request signal or upon detecting the termination of power to the coil 36 which indicates that the second clutch member 46 is now intended to be the disengaged position. When it is determined that the clutch should move to the disengaged position, the process 150 proceeds to step 154 in which the current profile is monitored for occurrence of a first spike.

When a first spike 110 is detected, it is compared in step 154 to a threshold which, if satisfied, indicates that the second clutch member 46 has moved to the disengaged position in a normal and prompt manner. That is, the second clutch member 46 is not in the previously described deactivated but engaged condition, and is instead deactivated and disengaged as intended. The process may proceed to step 156 in which the status of the differential 10 is stored in or added to memory, and then end at step 158 (which may loop back to the start of process 120 to check for a clutch activation signal).

If the threshold comparison in step 156 is not satisfied (i.e. does not indicate that the second clutch member 46 has moved to the disengaged position), then it is determined that the clutch is in the deactivated but engaged condition and the process proceeds to step 160.

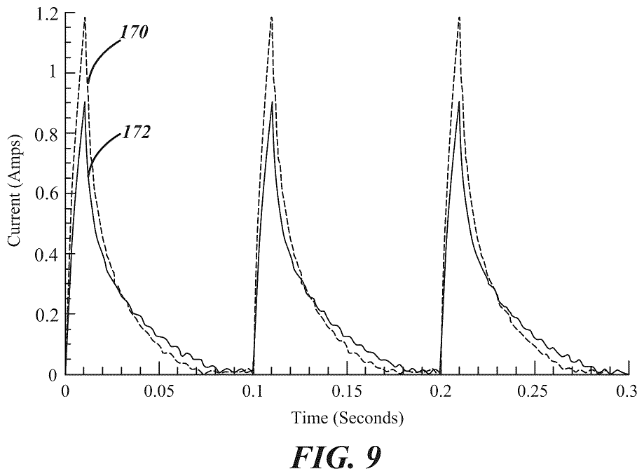

Proceeding to step 160, a detection current is applied to the coil 36 to determine the plunger position as a function of the magnitude of the resulting current sensed in the coil 36. The plunger position may be determined as a function of the inductance within the assembly when the detection current is applied, as the inductance within the assembly is different when the plunger 38 is retracted (clutch is disengaged) than when the plunger is advanced (clutch is engaged). When the plunger 38 in its advanced position, more of the plunger may be received within the envelope of the coil 36 (i.e. the plunger is received more closely to more of the turns of the coil) than when the plunger 38 is in its retracted position. When the plunger is in the retracted position the inductance in the assembly is less than when the plunger is in the advanced position. Thus, the slope and/or peak magnitude of a current profile in the coil 36 after application of the detection current will be greater when the plunger 38 is in the retracted position than when the plunger is in the advanced position. As noted above, the detection current may also keep the plunger engaged with the second clutch member 46 when the clutch 30 fails to disengage. Representative plots showing current in the coil 36 after several applications of a detection current are shown in FIG. 9, wherein the current in the coil 36 when the plunger 38 is retracted is shown by line 170 and the current in the coil when the plunger is advanced is shown by line 172. In the non-limiting example shown, the current in the coil 36 when the plunger 38 is retracted is about 1.25 amps and about 0.9 amps when the plunger is advanced. In this graph, the decay of the current in the coil 36 is not shown as the focus of the graph is on application of detection current(s) and the resulting current in the coil 36. The method may include a step in which a time period elapses or in which the current is monitored until it has sufficiently decayed, which may but need not include full decay of the current in the coil, before the process continues.

The detection current may be of a fixed magnitude (or frequency in a PWM system) and applied for a relatively short period of time. The detection current may be less than a current used to move the plunger 38 to the advanced position so that the detection current does not cause undesired movement of the plunger. The goal in this step is to determine plunger position, not to drive or move the plunger 38 to the advanced position. In one non-limiting example, the current may be applied at a relatively low frequency (in a PWM system), for example between 1 Hz and 1 kHz, and in at least some implementations about 10 Hz may be used. With the difference in current attributable to plunger position, the current in the coil 36 after application of a detection current can be compared in step 162 to one or more thresholds to determine the position of the plunger 38.

If in step 162 the current in the coil after application of the detection current indicates that the plunger 38 is in the retracted position, the process 150 may proceed to step 164 in which the differential status (i.e disengaged) is stored in memory and then end at step 166. Otherwise, another detection current may be applied to confirm the result.

If the current in the coil after application of the detection current indicates that the plunger 38 is not in the retracted position, the process may return to step 160 whereupon another detection current is applied to the coil 36. This may be repeated until the obtained result indicates that the plunger 38 has moved to the retracted position such that the clutch is disengaged, in which case the method may proceed to step 164 and then end at 166.

Application of the detection current and detection of the resulting current may be undertaken at other times as well, to detect the instantaneous position or state of the second clutch member 46. For example, even with detection of a current deviation that satisfies the one or more thresholds for such deviation and thereby indicates the clutch position, the detection current application scheme could be used to confirm the actual position. In at least some implementations (such as to detect an activated and engaged position), this may be done with a PWM current near 100% and slight differences in current falloff may be determined, as opposed to current rise.

A method of determining a differential assembly status generally includes receiving an activation signal at a clutch of the differential assembly. The clutch is configured to move in response to the activation signal between a disengaged position, corresponding to a disengaged differential 10, and an engaged position, corresponding to an engaged differential 10. The method further includes monitoring a current profile in the clutch and determining a status of the differential assembly from the current profile. If a deactivated but engaged position is detected, one or more instances of a detection current may be applied to the clutch. The resulting current in the coil of the clutch is indicative of the position of the clutch due to differences in the inductance in the clutch between its disengaged and engaged positions.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but instead with reference to the appended claims, along with the full scope of equivalents to which such claims are entitled. It is anticipated and intended that future developments will occur in the arts discussed herein, and that the disclosed assemblies and methods will be incorporated into such future embodiments. In sum, it should be understood that the invention is capable of modification and variation that is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. In the preceding description, various operating parameters and components are described for one or more exemplary embodiments. These specific parameters and components are included as examples and are not meant to be limiting.

Reference in the preceding description to “one example,” “an example,” “one embodiment,” “an embodiment”, “an implementation” or “at least some implementations” means that a particular feature, structure, or characteristic described in connection with the example is included in at least one example or implementation including one or more but not necessarily all innovative features or components. References to various examples, embodiments or implementations do not necessarily refer to the same example, embodiment or implementation each time it appears.

1. A method of determining the status of a clutch of a vehicle driveline disconnect device, comprising the steps of:
detecting termination of an activation signal for an actuator of a clutch through which torque is selectively transmitted to one or more axles of a vehicle;
determining that the clutch is in a second position and not the first position;
applying a detection current to the actuator, wherein the detection current is of a lower magnitude than the current of the activation signal; and
determining the position of the clutch as a function of the current in the actuator after application of the detection current.

2. The method of claim 1 which also includes, when the determined position of the clutch after application of the detection current is not the first position, applying another detection current to the actuator and determining again the position of the clutch after reapplication of the detection current.

3. The method of claim 1 wherein the clutch includes a first clutch member and a second clutch member that is movable relative to the first clutch member, and a spring is provided that resists movement of the second clutch member toward the first clutch member, and wherein the detection current does not provide a force great enough to overcome the spring force to an extent wherein the second clutch member becomes engaged with the first clutch member.

4. The method of claim 1 wherein the current in the actuator after application of the detection current is of a magnitude that corresponds to the inductance within the actuator which changes as the position of the actuator changes.

5. The method of claim 1 wherein the clutch includes a first clutch member and a second clutch member that is movable relative to the first clutch member, and the actuator includes a coil and a plunger that moves relative to the coil to move the second clutch member, and wherein the activation signal is applied to the coil to cause movement of the plunger in a direction associated with movement of the second clutch member away from the first clutch member, and the movement of the plunger induces a current in the actuator that causes a first spike in a current profile of the actuator and the step of determining that the clutch is in a second position and not the first position is accomplished by comparison of the first spike to at least one threshold.

6. The method of claim 5 wherein the at least one threshold relates to a magnitude of current change in the first spike, the duration of the spike, the time between occurrence of the spike and receiving the signal, occurrence of the spike before the current in the coil falls below a threshold current, or a combination of two or more of these things.

7. The method of claim 6 wherein the first spike satisfies the at least part of the at least one threshold when the first spike occurs before the current in the coil fully decays.

8. The method of claim 6 wherein the signal indicative that the clutch should be in the first position is the termination of an activation signal for the actuator, and wherein the first spike satisfies the at least part of the at least one threshold when the first spike occurs within 30 ms to 150 ms of the termination of the activation signal.

9. The method of claim 5 wherein the current in the actuator after application of the detection current is of a magnitude that corresponds to the inductance within the actuator which changes as a position of the plunger changes.

10. The method of claim 9 wherein a slope or a peak magnitude, or both, of the current in the actuator after application of the detection current is different when the plunger is in a first position than when the plunger is in a second position.

11. The method of claim 5 wherein the detection current is of lower magnitude than the current of the activation signal.

12. The method of claim 1 wherein the activation signal is applied to the coil to cause movement of the plunger, and movement of the plunger induces a current in the actuator that creates a first deviation in a current profile of the actuator, and wherein the step of determining that the clutch is in a second position and not the first position is accomplished at least in part by determining if the first deviation occurred in the current profile.

13. The system of claim 12 wherein the first deviation has a first deviation magnitude that is based on one or both of a total current change from a start of the first deviation to a peak of the first deviation, or the time duration of the deviation, and wherein the first deviation magnitude is compared to a first threshold to determine if the clutch is in the first position.

14. A driveline disconnect device, comprising:
an outer housing;
two or more pinion gears received in the outer housing a pinion shaft;
a pair of side gears received in the outer housing and meshed with the two or more pinion gears, the side gears are each adapted to be connected to a separate shaft that drives a wheel of a vehicle;
an inner housing coupled to the pinion shaft;
a clutch having a first clutch member that is connected to the inner housing, and a second clutch member that is connected to the outer housing for rotation with the outer housing, and the second clutch member is movable relative to the first clutch member to define an engaged position in which torque is transmitted through the clutch and to the side gears, and a disengaged position in which torque is not transmitted through the clutch and to the side gears;
an actuator having a coil and a plunger that moves relative to the coil to move the second clutch member; and
a controller adapted to execute instructions to:
detect an activation signal of an actuator of the clutch indicative that the clutch should be in the disengaged position;
determine that the clutch is in the engaged position and not the disengaged position;
apply a detection current to the actuator, wherein the detection current is of a lower magnitude than the current of the activation signal;
determine the position of the clutch as a function of the current in the actuator after application of the detection current; and
when the determined position of the clutch after application of the detection current is not the disengaged position, apply another detection current to the actuator and determine again the position of the clutch after reapplication of the detection current.

15. The system of claim 14 wherein the movement of the plunger induces a current in the actuator that causes a first spike in a current profile of the actuator, and determining that the clutch is in a second position and not the first position is accomplished by comparison of the first spike to at least one threshold.

16. The system of claim 15 wherein the at least one threshold relates to a magnitude of current change in the first spike, the duration of the spike, the time between occurrence of the spike and receiving the signal, occurrence of the spike before the current in the coil falls below a threshold current, or a combination of two or more of these things.

17. The system of claim 16 wherein the first spike satisfies the at least part of the at least one threshold when the first spike occurs before the current in the coil fully decays.

18. The system of claim 14 wherein the current in the actuator after application of the detection current is of a magnitude that corresponds to the inductance within the actuator which changes as a position of the plunger changes.

19. The system of claim 14 wherein the activation signal is applied to the coil to cause movement of the plunger, and movement of the plunger induces a current in the actuator that creates a first deviation in a current profile of the actuator, and wherein the step of determining that the clutch is in a second position and not the first position is accomplished at least in part by determining if the first deviation occurred in the current profile.

20. The system of claim 19 wherein the first deviation has a first deviation magnitude that is based on one or both of a total current change from a start of the first deviation to a peak of the first deviation, or the time duration of the deviation, and wherein the first deviation magnitude is compared to a first threshold to determine if the clutch is in the first position.
